(19) United States
(12) Patent Application Publication
(10) Pub. No.: US 2022/0067882 A1
(43) Pub. Date: Mar. 3, 2022

(54) IMAGE PROCESSING DEVICE, COMPUTER READABLE RECORDING MEDIUM, AND METHOD OF PROCESSING IMAGE

(71) Applicant: TOYOTA JIDOSHA KABUSHIKI KAISHA, Toyota-shi (JP)

(72) Inventors: Toshiaki OHGUSHI, Tokyo (JP); Kenji HORIGUCHI, Tokyo (JP); Masao YAMANAKA, Tokyo (JP)

(73) Assignee: TOYOTA JIDOSHA KABUSHIKI KAISHA, Toyota-shi (JP)

(21) Appl. No.: 17/376,887

(22) Filed: Jul. 15, 2021

(30) Foreign Application Priority Data
Aug. 25, 2020 (JP) 2020-142139

(51) Int. Cl. G06T 5/00; G06T 5/50; G06N 3/08; G06N 3/04

(52) U.S. Cl. CPC G06T 5/001; G06T 5/50; G06T 2207/20224; G06N 3/0454; G06N 3/08

(57) ABSTRACT

An image processing device includes a processor including hardware, the processor being configured to: generate a semantic label image by estimating a semantic label for each pixel of an input image by using a discriminator trained in advance; generate a restored image by estimating an original image from the semantic label image; calculate a first difference between the input image and the restored image; and update an estimation parameter for estimating the semantic label or an estimation parameter for estimating the original image based on the first difference.

The present application claims priority to and incorporates by reference the entire contents of Japanese Patent Application No. 2020-142139 filed in Japan on Aug. 25, 2020.

### BACKGROUND

The present disclosure relates to an image processing device, a computer readable recording medium and a method of processing an image.

JP 2018-194912 A discloses a technique for improving the accuracy of estimating semantic labels by estimating the semantic labels from an input image, creating training data (correct label image) based on the degree of difficulty of estimating the semantic labels, and causing the training data to be learned.

### SUMMARY

In the technique of JP 2018-194912 A, it is necessary to create training data for a large quantity of images in order to maintain accuracy in a wide variety of scenes. In general, the creation of training data requires high cost. Thus, a technique has been desired that improves estimation accuracy without preparing a large quantity of training data.

There is a need for an image processing device, a computer readable recording medium and a method of processing an image that improve estimation accuracy without preparing a large quantity of training data.

According to one aspect of the present disclosure, there is provided an image processing device including a processor including hardware, the processor being configured to: generate a semantic label image by estimating a semantic label for each pixel of an input image by using a discriminator trained in advance; generate a restored image by estimating an original image from the semantic label image; calculate a first difference between the input image and the restored image; and update an estimation parameter for estimating the semantic label or an estimation parameter for estimating the original image based on the first difference.

### BRIEF DESCRIPTION OF THE DRAWINGS

FIG. 1 is a block diagram illustrating a configuration of an image processing device according to a first embodiment;

FIG. 2 is a block diagram illustrating a configuration of an image processing device according to a second embodiment;

FIG. 3 is a block diagram illustrating a configuration of an image processing device according to a third embodiment;

FIG. 4 is a block diagram illustrating a configuration of an image processing device according to a fourth embodiment;

FIG. 5 is a block diagram illustrating a configuration of an image processing device according to a fifth embodiment;

FIG. 6 is a block diagram illustrating a configuration of an image processing device according to a sixth embodiment;

FIG. 7 is a block diagram illustrating a configuration of an image processing device according to a seventh embodiment;

FIG. 8 is a block diagram illustrating a configuration of an image processing device according to an eighth embodiment; and

FIG. 9 is a block diagram illustrating a configuration of an image processing device according to a ninth embodiment.

### DETALLED DESCRIPTION

An image processing device, a computer readable recording medium storing an image processing program, and a method of processing an image (image processing method) according to embodiments of the present disclosure will be described with reference to the drawings. Note that components in the following embodiments include those that may be easily replaced by a person skilled in the art or that are substantially identical.

The image processing device according to the present disclosure is for performing semantic segmentation on an image that is input (hereinafter referred to as an “input image”). For example, each embodiment of the image processing device described below is realized by functioning of a general-purpose computer such as a workstation or a personal computer including a processor such as a central processing unit (CPU), a digital signal processor (DSP), or a field-programmable gate array (FPGA), a memory (primary memory or auxiliary memory) such as a random access memory (RAM) or a read only memory (ROM), and a communication unit (communication interface).

Note that units of the image processing device may be realized by functioning of a single computer, or may be realized by functioning of a plurality of computers having different functions. In addition, although an example of applying the image processing device to the field of vehicles will be described below, the image processing device may also be applied to a wide range of fields other than the vehicles as long as semantic segmentation is required.

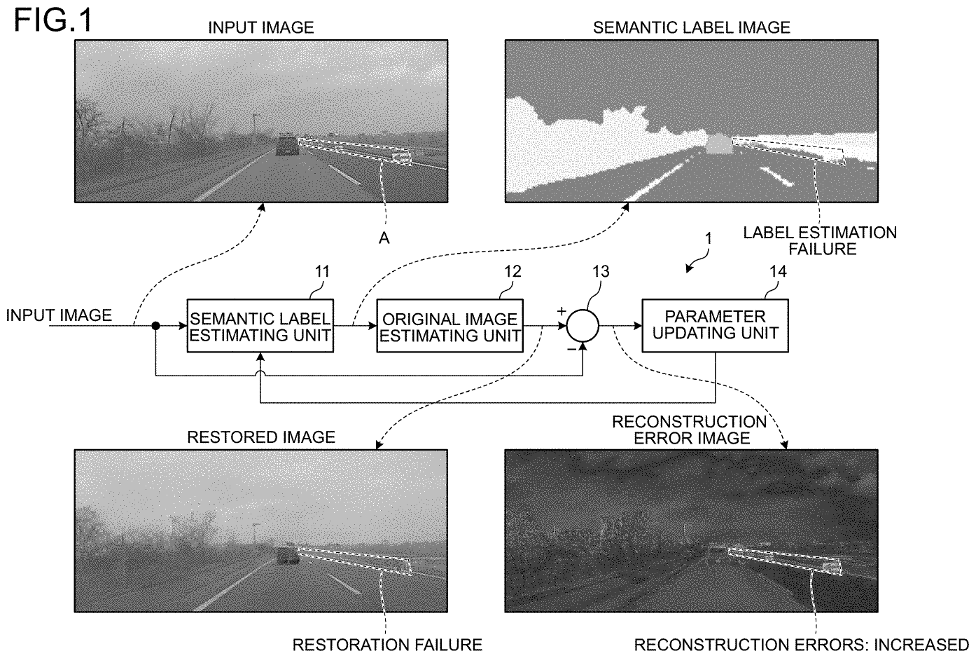

An image processing device 1 according to a first embodiment will be described with reference to FIG. 1. The image processing device 1 includes a semantic label estimating unit 11, an original image estimating unit 12, a difference calculating unit 13, and a parameter updating unit 14.

The semantic label estimating unit 11 generates a semantic label image by estimating a semantic label for each pixel of an input image by using a discriminator trained in advance and a pre-trained parameter. Specifically, the semantic label estimating unit 11 estimates a semantic label for each pixel of an input image by using a discriminator trained in advance and a pre-trained parameter, and assigns the semantic label. The semantic label estimating unit 11 thus converts the input image into a semantic label image, and outputs the semantic label image to the original image estimating unit 12. Note that the input image input to the semantic label estimating unit 11 may be, for example, an image captured by an in-vehicle camera provided in a vehicle or an image captured in advance.

The semantic label estimating unit 11 is configured as a network formed by stacking elements such as a convolution layer, an activation layer (such as a ReLU layer or a Softmax layer), a pooling layer, and an upsampling layer in a multi-layered manner by using a technique based on deep learning (in particular, convolutional neural network (CNN)), for example. In addition, examples of the technique for training the discriminator and the pre-trained parameter used in the semantic label estimating unit 11 include a conditional random field (CRF)-based technique, a technique combining deep learning and conditional random field (CRF), a technique of performing real-time estimation using a multi-resolution image, and the like.

The original image estimating unit 12 generates a restored image by estimating the original image from the semantic label image generated by the semantic label estimating unit 11 by using a discriminator trained in advance and a pre-trained parameter. Specifically, the original image estimating unit 12 restores the original image from the semantic label image by using a discriminator and a pre-trained parameter. The original image estimating unit 12 thus converts the semantic label image into a restored image, and outputs the restored image to the difference calculating unit 13.

The original image estimating unit 12 is configured as a network formed by stacking elements such as a convolution layer, an activation layer (such as a ReLU layer or a Softmax layer), a pooling layer, and an upsampling layer in a multi-layered manner by using a technique based on deep learning (in particular, convolutional neural network (CNN)), for example. In addition, examples of the technique for training the discriminator and the pre-trained parameter used in the original image estimating unit 12 include a cascaded refinement network (CRN)-based technique, a Pix2PixHD-based technique, and the like.

The difference calculating unit 13 calculates the difference (first difference) between the input image and the restored image generated by the original image estimating unit 12, and outputs the calculation result to the parameter updating unit 14. For example, the difference calculating unit 13 may calculate a simple, per-pixel difference (I(x,y)−P(x,y)) for image information (I(x,y)) of the input image and image information P(x,y) of the restored image. The difference calculating unit 13 may also calculate a per-pixel correlation based on equation (1) below for image information (I(x,y)) of the input image and image information P(x,y) of the restored image.

∥I(x, y)−P(x, y)∥ⁿ(n=1 OR 2)

The difference calculating unit 13 may also perform difference comparison after performing predetermined image conversion f(·) on image information (I(x,y)) of the input image and image information P(x,y) of the restored image. That is, the difference calculating unit 13 may calculate “f(I(x,y))−f(P(x,y))”. Note that examples of the image conversion f(·) include “perceptual loss”, which uses hidden layer output of a deep learner (such as vgg16 or vgg19). Note that, in any case of using the above-mentioned methods, the difference calculated by the difference calculating unit 13 is output as an image. In the present disclosure, this image indicating the difference calculated by the difference calculating unit 13 is defined as a “reconstruction error image”.

The parameter updating unit 14 updates an estimation parameter for estimating the semantic label from the input image by the semantic label estimating unit 11 based on the difference (reconstruction error image) calculated by the difference calculating unit 13.

Here, FIG. 1 illustrates an example of the input image at the upper left, an example of the semantic label image at the upper right, an example of the restored image at the lower left, and an example of the reconstruction error image at the lower right. For example, it is assumed that a warning board appears at the lower right of the input image as shown in portion A of the input image. In this case, in the semantic label estimating unit 11, if the learning of an image (correct label image) containing the warning board has not been performed, label estimation failure may occur for the portion of this warning board (see the lower-right portion of the semantic label image in FIG. 1). When such label estimation failure occurs, restoration failure also occurs in the restored image generated by the original image estimating unit 12 (see the lower-right portion of the restored image in the figure), which results in increased reconstruction errors in the reconstruction error image (see the lower-right portion of the reconstruction error image in the figure).

Thus, in the image processing device 1, the parameter updating unit 14 updates the estimation parameter of the semantic label estimating unit 11 such that the reconstruction errors in the reconstruction error image are decreased. For example, in deep learning, the estimation parameter is updated by error backpropagation or the like. In this manner, even in the case of using an input image for which no training data (correct label image) exists, the accuracy of estimating the semantic label may be improved.

That is, in the image processing device 1, simplified training is initially performed by using a limited and small quantity of training data (correct label images), and subsequently the estimation parameter of the semantic label estimating unit 11 is updated based on the difference between the input image and the restored image. Thus, in the image processing device 1, it is possible to improve the accuracy of estimating the semantic label without using a large quantity of training data. Moreover, in the image processing device 1, it is not necessary to prepare a large quantity of training data (for example, to manually assign correct labels to the input image), and thus the cost for creating the training data may be reduced.

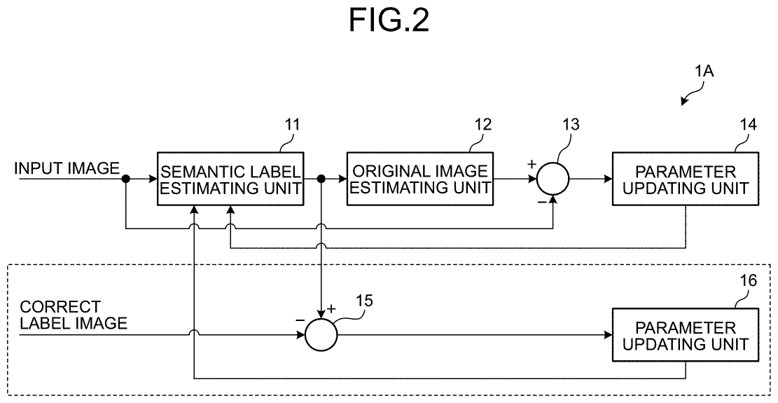

An image processing device 1A according to a second embodiment will be described with reference to FIG. 2. Note that, in the figure, the same components as those in the above-described embodiment are given the same reference characters and will not be described repeatedly. In addition, in the figure, components different than in the first embodiment are enclosed by broken lines. The image processing device 1A includes a semantic label estimating unit 11, an original image estimating unit 12, a difference calculating unit 13, a parameter updating unit 14, a difference calculating unit 15, and a parameter updating unit 16.

The difference calculating unit 15 calculates the difference (second difference) between a correct label image prepared in advance and the semantic label image estimated by the semantic label estimating unit 11, and outputs the calculation result to the parameter updating unit 16.

Here, the “correct label image” refers to a semantic label image corresponding to the input image and in which the estimation probability of each semantic label is 100%. Typically, in the semantic label image generated by the semantic label estimating unit 11, the estimation probability of each semantic label is set, such as “the probability of the sky is 80%, the probability of a road is 20%, . . . ”, for each pixel. On the other hand, in the correct label image, the estimation probability of each semantic label is set to 100%, such as “the probability of the sky is 100%”. This correct label image may be manually created by human or automatically created by a high-grade learner.

In the same way as the difference calculating unit 13, the difference calculating unit 15 may calculate a simple, per-pixel difference for image information of the input image and image information of the correct label image, may calculate a per-pixel correlation based on equation (1) above for them, or may perform difference comparison after performing predetermined image conversion f(·) on them.

The parameter updating unit 16 updates an estimation parameter for estimating the semantic label from the input image by the semantic label estimating unit 11 based on the difference calculated by the difference calculating unit 15. For example, in deep learning, the estimation parameter is updated by error backpropagation or the like.

In the image processing device 1A, in the case where a correct label image corresponding to the input image may be obtained, the parameter updating unit 16 updates the estimation parameter of the semantic label estimating unit 11 such that label data (correct label data) included in the correct label image and the semantic label estimated by the semantic label estimating unit 11 coincide with each other, in addition to the parameter update using reconstruction errors in the parameter updating unit 14. In this process, the parameter updating unit 14 and the parameter updating unit 16 may be operated separately from each other or may simultaneously perform the update by calculating a weighted sum of their update amounts.

In the image processing device 1A, by performing the parameter update using the correct label image in addition to the parameter update using reconstruction errors, the accuracy of estimating the semantic label may be further improved. In addition, in the image processing device 1A, by performing training using reconstruction errors, the accuracy of estimating the semantic label may be improved as compared to the case where training is performed by using only the input image and the correct label image.

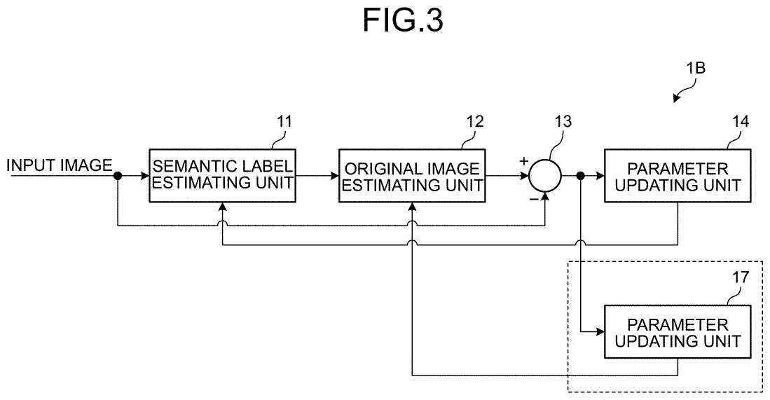

An image processing device 1B according to a third embodiment will be described with reference to FIG. 3. Note that, in the figure, the same components as those in the above-described embodiment are given the same reference characters and will not be described repeatedly. In addition, in the figure, components different than in the first embodiment are enclosed by broken lines. The image processing device 1B includes a semantic label estimating unit 11, an original image estimating unit 12, a difference calculating unit 13, a parameter updating unit 14, and a parameter updating unit 17.

The parameter updating unit 17 updates an estimation parameter for estimating the original image from the semantic label image by the original image estimating unit 12 based on the difference (first difference) calculated by the difference calculating unit 13.

In the image processing device 1B, the parameter updating unit 17 updates the estimation parameter of the original image estimating unit 12 such that reconstruction errors of the reconstruction error image are decreased, in addition to updating the estimation parameter of the semantic label estimating unit 11 by the parameter updating unit 14 such that reconstruction errors of the reconstruction error image are decreased. For example, in deep learning, the estimation parameter is updated by error backpropagation or the like. In this manner, even in the case of using an input image for which no correct label image exists, the accuracy of estimating the original image may be improved.

Note that the image processing device 1B may be operated in combination with the image processing device 1A. In this case, the update of the estimation parameter for the semantic label using reconstruction errors, the update of the estimation parameter for the semantic label using the correct label image, and the update of the estimation parameter for the original image using reconstruction errors are performed. By operating the image processing device 1B and the image processing device 1A in combination, the accuracy of estimating the original image may be further improved.

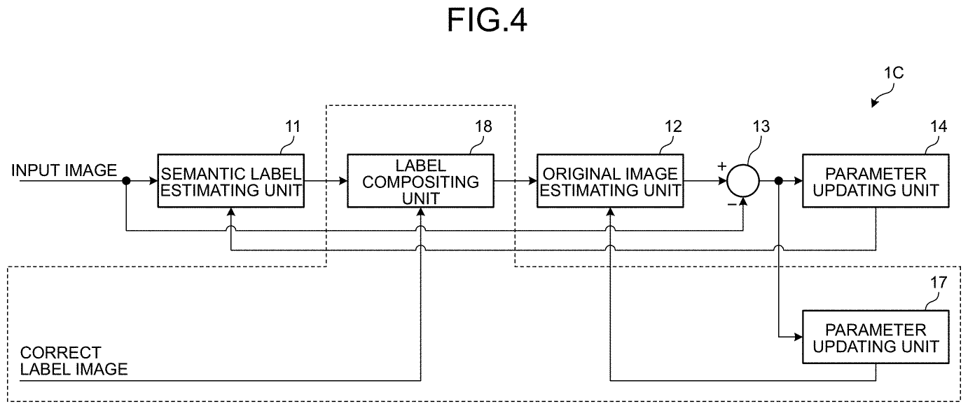

An image processing device 1C according to a fourth embodiment will be described with reference to FIG. 4. Note that, in the figure, the same components as those in the above-described embodiment are given the same reference characters and will not be described repeatedly. In addition, in the figure, components different than in the first embodiment are enclosed by broken lines. The image processing device 1C includes a semantic label estimating unit 11, a label compositing unit 18, an original image estimating unit 12, a difference calculating unit 13, a parameter updating unit 14, and a parameter updating unit 17.

The label compositing unit 18 composites a correct label of a correct label image and the semantic label of the semantic label image generated by the semantic label estimating unit 11, and outputs an image containing the composite label to the original image estimating unit 12. Examples of the compositing method in the label compositing unit 18 include a weighted sum of the correct label image and the semantic label image, random selection of images (selecting the correct label image or the semantic label image according to probability), partial composition (averaging or randomly selecting partial images), and the like. The original image estimating unit 12 then generates a restored image by estimating the original image from the image composited by the label compositing unit 18.

In the image processing device 1C, in the case where a correct label image corresponding to the input image may be obtained, the correct label image and the semantic label image generated by the semantic label estimating unit 11 are composited, and a restored image is generated by the original image estimating unit 12 based on the composite image. In this manner, by performing the parameter update for the original image estimating unit 12 using the correct label image, the accuracy of estimating the original image may be further improved.

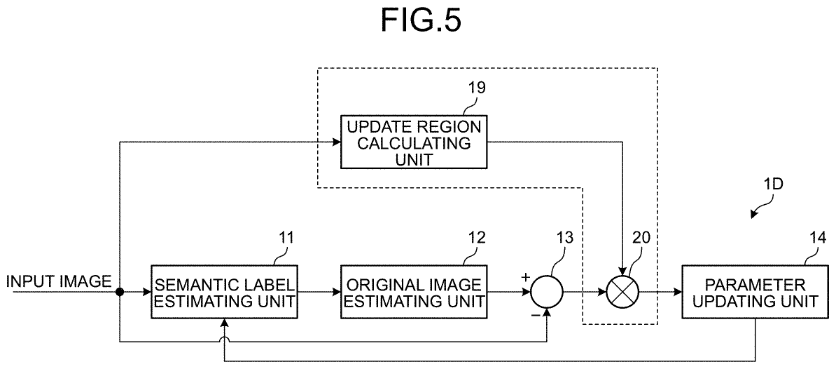

An image processing device 1D according to a fifth embodiment will be described with reference to FIG. 5. Note that, in the figure, the sane components as those in the above-described embodiment are given the same reference characters and will not be described repeatedly. In addition, in the figure, components different than in the first embodiment are enclosed by broken lines. The image processing device 1D includes a semantic label estimating unit 11, an or image estimating unit 12, a difference calculating unit 13, a region compositing unit 20, a parameter updating unit 14, and an update region calculating unit 19.

The update region calculating unit 19 calculates a particular region of the input image as an update region. The update region calculating unit 19 masks a region for which no training is required (such as the upper half or the lower half), a region for which it takes time for training due to low lightness, or the like in the input image, for example, and outputs information other than the masked region to the region compositing unit 20 as an update region.

The region compositing unit 20 composites the reconstruction error image calculated by the difference calculating unit 13 and the update region calculated by the update region calculating unit 19, and outputs it to the parameter updating unit 14. For example, the region compositing unit 20 performs the composition by performing multiplication, addition, logic AND, or logic OR on the reconstruction error image and the update region. The parameter updating unit 14 then updates an estimation parameter for estimating the semantic label for the update region of the composite image.

In the image processing device 1D, in updating the estimation parameter for the semantic label estimating unit 11, the region for which to update the estimation parameter is limited to eliminate training for unnecessary portions. In this manner, it is possible to improve estimation accuracy for portions for which training is required and increase the training speed.

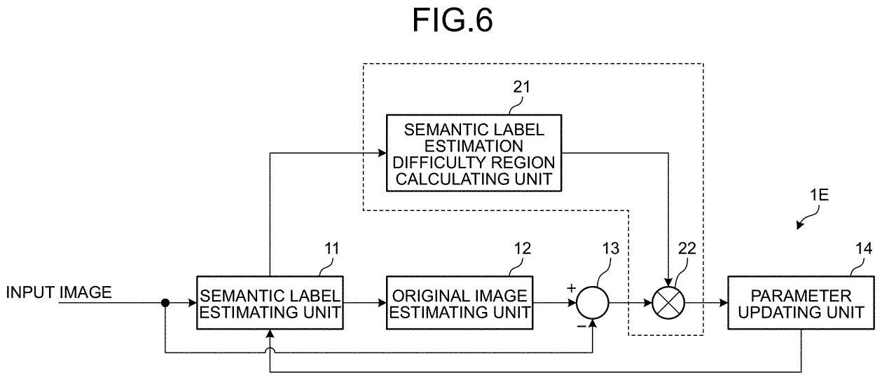

An image processing device 1E according to a sixth embodiment will be described with reference to FIG. 6. Note that, in the figure, the same components as those in the above-described embodiment are given the same reference characters and will not be described repeatedly. In addition, in the figure, components different than in the first embodiment are enclosed by broken lines. The image processing device 1E includes a semantic label estimating unit 11, an original image estimating unit 12, a difference calculating unit 13, a region compositing unit 22, a parameter updating unit 14, and a semantic label estimation difficulty region calculating unit 21.

The semantic label estimation difficulty region calculating unit 21 calculates an estimation difficulty region of the input image in which it is difficult to estimate the semantic label. Specifically, the semantic label estimation difficulty region calculating unit 21 calculates a region for which it is worth updating the estimation parameter by using information of the semantic label estimated by the semantic label estimating unit 11, and outputs information of the region to the region compositing unit 22 as an estimation difficulty region.

For example, assuming that the estimation probability of each semantic label is “pᵢ”, an index of the estimation difficulty region may be indicated by, for example, the entropy “Σᵢpᵢlogpᵢ” of the estimation probabilities of the semantic labels, the standard deviation STD (pᵢ) of the estimation probabilities of the semantic labels, the difference “max_{i,j}(pᵢ−pⱼ)” between the maximum values of the estimation probabilities of the semantic labels, or the like.

The region compositing unit 22 composites the reconstruction error image calculated by the difference calculating unit 13 and the estimation difficulty region calculated by the semantic label estimation difficulty region calculating unit 21, and outputs it to the parameter updating unit 14. For example, the semantic label estimation difficulty region calculating unit 21 performs the composition by performing multiplication, addition, logic AND, or logic OR on the reconstruction error image and the estimation difficulty region. The parameter updating unit 14 then updates an estimation parameter for estimating the semantic label from the input image by the semantic label estimating unit 11 for the estimation difficulty region of the composite image.

In the image processing device 1E, in updating the estimation parameter for the semantic label estimating unit 11, the region for which to update the estimation parameter is limited to a region in which it is difficult to estimate the semantic label to eliminate training for unnecessary portions. In this manner, it is possible to improve estimation accuracy for portions for which training is required and increase the training speed.

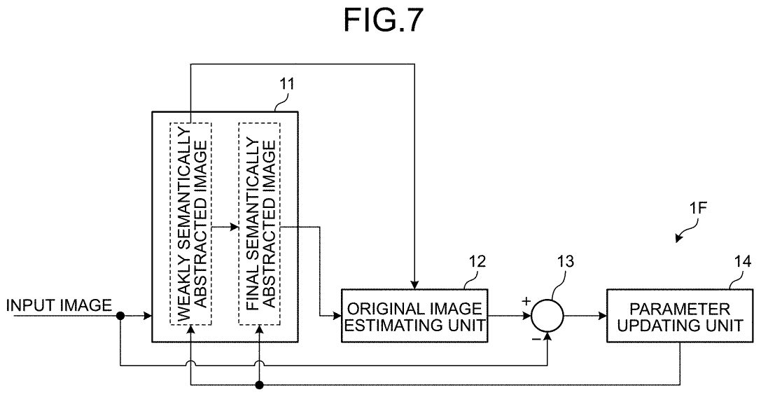

An image processing device 1F according to a seventh embodiment will be described with reference to FIG. 7. Note that, in the figure, the same components as those in the above-described embodiment are given the same reference characters and will not be described repeatedly. In addition, in the figure, components different than in the first embodiment are enclosed by broken lines. The image processing device 1F includes a semantic label estimating unit 11, an original image estimating unit 12, a difference calculating unit 13, and a parameter updating unit 14.

The semantic label estimating unit 11 uses a deep learning-based technique as the technique for training the discriminator and the pre-trained parameter. The semantic label estimating unit 11 outputs, in addition to a semantic label image generated in the final layer of the deep learning (that is, an estimation result of semantic labels estimated in the final layer), a semantic label image generated in an intermediate layer (hidden layer) of the deep learning (that is, an estimation result of semantic labels estimated in the intermediate layer) to the original image estimating unit 12. The original image estimating unit 12 then generates a restored image by estimating the original image by using one or both of the semantic label image generated in the intermediate layer and the semantic label image generated in the final layer.

In the image processing device 1F, the original image is estimated based on a semantic label image that is generated in an intermediate layer of the deep learning and is not completely abstracted, in addition to a semantic label image that is generated in the final layer of the deep learning and is completely abstracted. In this manner, since the semantic label image from the intermediate layer has a higher degree of restoration, the quality of the restored image is improved for portions for which semantic labels are correctly estimated, and the accuracy (S/N) of detecting portions for which the estimation of semantic labels fails is improved.

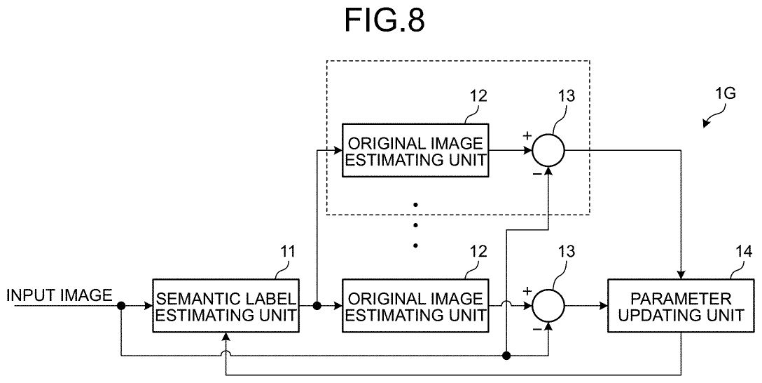

An image processing device 1G according to an eighth embodiment will be described with reference to FIG. 8. Note that, in the figure, the same components as those in the above-described embodiment are given the same reference characters and will not be described repeatedly. In addition, in the figure, components different than in the first embodiment are enclosed by broken lines. The image processing device 1G includes a semantic label estimating unit 11, a plurality of original image estimating units 12, a plurality of difference calculating units 13, and a parameter updating unit 14.

In the image processing device 1G, a plurality of (N) original image estimating units 12 and a plurality of (N) difference calculating units 13 are provided. The plurality of original image estimating units 12 may be composed of networks having respective different configurations, and their discriminators and pre-trained parameters may be trained by respective different training techniques (such as CRN, Pix2PixHD, and other deep learning algorithm).

The plurality of original image estimating units 12 generate a plurality of restored images by estimating the original image from the semantic label image by using a plurality of different restoring methods, for example. Note that different semantic label images may be input to the plurality of original image estimating units 12, for example, an i-th semantic label image (for example, only a vehicle label) may be input to an i-th original image estimating unit 12.

In the image processing device 1G, by integrating the results of estimating the original image from the plurality of original image estimating units 12, reconstruction errors may be accurately estimated. In addition, in the case of separately inputting particular semantic labels to the original image estimating units 12, image categories to be handled by each original image estimating unit 12 are limited, and thus the performance of restoring the original image is improved.

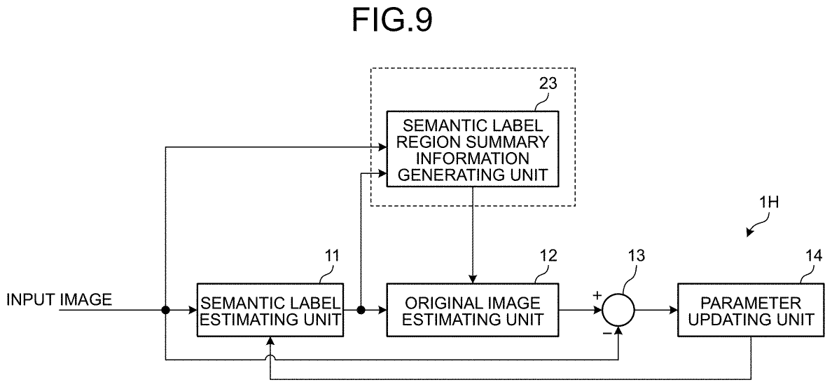

An image processing device 1H according to a ninth embodiment will be described with reference to FIG. 9. Note that, in the figure, the same components as those in the above-described embodiment are given the same reference characters and will not be described repeatedly. In addition, in the figure, components different than in the first embodiment are enclosed by broken lines. The image processing device 1H includes a semantic label estimating unit 11, an original image estimating unit 12, a difference calculating unit 13, a parameter updating unit 14, and a semantic label region summary information generating unit 23.

The semantic label region summary information generating unit 23 generates region summary information of the semantic label based on the input image and the semantic label image generated by the semantic label estimating unit 11, and outputs it to the original image estimating unit 12. Examples of this region summary information include a color average, a maximum value, a minimum value, a standard deviation, a region surface area, a spatial frequency, an edge image (such as the Canny method, which is algorithm for approximately extracting an edge image from an image), a partially masked image, and the like, of each semantic label.

To restore the original image from the semantic label image, the original image estimating unit 12 then generates a restored image by estimating the original image from the semantic label image by using the region summary information generated by the semantic label region summary information generating unit 23.

In the image processing device 1H, by estimating the original image by using the region summary information, the quality of the restored image is improved for portions for which semantic labels are correctly estimated, and thus the accuracy (S/N) of detecting portions for which the estimation of semantic labels fails may be enhanced.

Specifically, the image processing devices 1 to 1H described above are used as “devices for training the semantic label estimating unit” for training the semantic label estimating unit 11 at low cost and in a simplified manner. That is, the image processing devices 1 to 1H are not provided in a vehicle, and the semantic label estimating unit 11 is trained by the image processing devices 1 to 1H in a development environment of a center or the like and then introduced (for example, provided in advance or updated over the air (OTA)) into an obstacle identification device disposed in the vehicle or the center. Then, images from an in-vehicle camera are input to the semantic label estimating unit 11 (which may be provided. in the vehicle or on the center side) to identify obstacles on the road, for example.

In accordance with the present disclosure, it is possible to improve estimation accuracy without creating a large quantity of training data.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing device comprising a processor comprising hardware, the processor being configured to:
generate a semantic label image by estimating a semantic label for each pixel of an input image by using a discriminator trained in advance;
generate a restored image by estimating an original image from the semantic label image;
calculate a first difference between the input image and the restored image; and
update an estimation parameter for estimating the semantic label or an estimation parameter for estimating the original image based on the first difference.

2. The image processing device according to claim 1, wherein the processor is configured to:
calculate a second difference between a correct label image prepared in advance and the semantic label image; and
update an estimation parameter for estimating the semantic label based on the first difference and the second difference.

3. The image processing device according to claim 1, wherein the processor is configured to:
composite a correct label image and the semantic label image; and
generate the restored image by estimating an original image from a composite image.

4. The image processing device according to claim 1, wherein the processor is configured to:
calculate a particular region of the input image as an update region; and
update an estimation parameter for estimating the semantic label for the update region.

5. The image processing device according to claim 1, wherein the processor is configured to:
calculate an estimation difficulty region of the input image in which it is difficult to estimate the semantic label;
composite the estimation difficulty region and a reconstruction error image indicating the first difference; and
update an estimation parameter for estimating the semantic label based on a composite image.

6. The image processing device according to claim 1, wherein
the discriminator is trained by deep learning, and
the processor is configured to generate the restored image by estimating the original image by using a semantic label image generated in an intermediate layer of the deep learning and a semantic label image generated in a final layer of the deep learning.

7. The image processing device according to claim 1, wherein the processor is configured to:
generate a plurality of restored images by estimating an original image from the semantic label image by using a plurality of different restoring methods;
calculate a first difference between the input image and each of the plurality of restored images; and
update an estimation parameter for estimating the semantic label based on a plurality of the first differences.

8. The image processing device according to claim 1, wherein the processor is configured to:
generate region summary information of the semantic label; and
generate the restored image by estimating an original image from the semantic label image by using the region summary information.

9. A non-transitory computer-readable recording medium on which an executable program is recorded, the program causing a processor of a computer to execute:
generating a semantic label image by estimating a semantic label for each pixel of an input image by using a discriminator trained in advance;
generating a restored. image by estimating an original image from the semantic label image;
calculating a first difference between the input image and the restored image; and
updating an estimation parameter for estimating the semantic label or an estimation parameter for estimating the original image based on the first difference.

10. The non-transitory computer-readable recording medium according to claim 9, wherein the program causes the processor to execute:
calculating a second difference between a correct label image prepared in advance and the semantic label image; and
updating an estimation parameter for estimating the semantic label based on the first difference and the second difference.

11. The non-transitory computer-readable recording medium according to claim 9, wherein the program causes the processor to execute:
compositing a correct label image and the semantic label image; and
generating the restored image by estimating an original image from a composite image.

12. The non-transitory computer-readable recording medium according to claim 9, wherein the program causes the processor to execute:
calculating a particular region of the input image as an update region; and
updating an estimation parameter for estimating the semantic label for the update region.

13. The non-transitory computer-readable recording medium according to claim 9, wherein the program causes the processor to execute:
calculating an estimation difficulty region of the input image in which it is difficult to estimate the semantic label;
compositing the estimation difficulty region and a reconstruction error image indicating the first difference; and
updating an estimation parameter for estimating the semantic label based on a composite image.

14. The non-transitory computer-readable recording medium according to claim 9, wherein
the discriminator is trained by deep learning, and
the program causes the processor to execute generating the restored image by estimating the original image by using a semantic label image generated in an intermediate layer of the deep learning and a semantic label image generated in a final layer of the deep learning.

15. The non-transitory computer-readable recording medium according to claim 9, wherein the program causes the processor to execute:
generating a plurality of restored images by estimating an original image from the semantic label image by using a plurality of different restoring methods;
calculating a first difference between the input image and each of the restored images; and
updating an estimation parameter for estimating the semantic label based on a plurality of the first differences.

16. The non-transitory computer-readable recording medium according to claim 9, wherein the program causes the processor to execute:
generating region summary information of the semantic label; and
generating the restored image by estimating an original image from the semantic label image by using the region summary information.

17. A method of processing an image, the method comprising:
generating a semantic label image by estimating a semantic label for each pixel of an input image by using a discriminator trained in advance;
generating a restored. image by estimating an original image from the semantic label image;
calculating a first difference between the input image and the restored image; and
updating an estimation parameter for estimating the semantic label or an estimation parameter for estimating the original image based on the first difference.
